(19) United States
(12) Patent Application Publication
(10) Pub. No.: US 2008/0262834 A1
(43) Pub. Date: Oct. 23, 2008

(54) Sound Separating Device, Sound Separating Method, Sound Separating Program, and Computer-Readable Recording Medium

(76) Inventors: Kensaku Obata, Saitama (JP); Yoshiki Ohta, Saitama (JP)

Correspondence Address: FOLEY AND LARDNER LLP;SUITE 500, 3000 K STREET NW, WASHINGTON, DC, 20007, US

(21) Appl. No.: 11/884,736

(22) PCT Filed: Feb. 9, 2006
(86) PCT No.: PCT/JP2006/302221

§ 371 Date: Aug. 21, 2007

(30) Foreign Application Priority Data
Feb. 25, 2005 (JP) 2005-051680
Aug. 24, 2005 (JP) 2005-243461

(51) Int. Cl. G06F 15/00

(52) U.S. Cl. 704/200

(57) ABSTRACT

A sound separating apparatus includes a converting unit that respectively converts signals of two channels into frequency domains by a time unit, the signals representing sounds from sound sources. The apparatus also includes a localization-information calculating unit that calculates localization information regarding the frequency domains and a cluster analyzing unit that classifies the localization information into clusters and respectively calculates central values of the clusters. Finally, the apparatus further includes a separating unit that inversely converts, into a time domain, a value that is based on the central value and the localization information, and separates a sound from a given sound source included in the sound sources.

### TECHNICAL FIELD

The present invention relates to a sound separating apparatus, a sound separating method, a sound separating program, and a computer-readable recording medium for separating sound represented by two signals into respective sound sources. However, use of the present invention is not limited to the sound separating apparatus, the sound separating method, the sound separating program, and the computer-readable recording medium.

### BACKGROUND ART

Several proposals have been made on a technology for extracting only a sound in a specific direction. For example, there is a technology for presuming sound source positions based on an arrival time difference between signals actually recorded by a microphone to take out sounds for respective directions (refer to, for example, Patent Documents 1, 2, and 3).

Patent Document 1: Japanese Patent Application Laid-Open Publication No. H10-313497

Patent Document 2: Japanese Patent Application Laid-Open Publication No. 2003-271167

Patent Document 3: Japanese Patent Application Laid-Open Publication No. 2002-44793

### DISCLOSURE OF INVENTION

### Problem to be Solved by the Invention

However, when a sound extraction for each sound source is performed using conventional techniques, the number of channels of a signal used for signal processing must exceed the number of sound sources. In addition, when a sound source separation technique in which the number of channels is less than the number of sound sources (refer to, for example, Patent Documents 1, 2, and 3) is used, this technology is applicable only to recording signals in a real sound field where arrival time differences can be observed. Furthermore, only a frequency coincident to an identified direction is taken out, and thus there have been problems that discontinuity of a spectrum has been caused, thereby degrading sound quality. Moreover, this technology is limited to processing of real sound sources, and the time difference cannot be observed in existing music sources, such as a CD, thus causing a problem that could the technology cannot be used. Furthermore, there have been problems in that sound sources from the signals of two channels or more cannot be separated.

Therefore, in order to solve the problems confronting the conventional technology mentioned above, it is an object of the present invention to provide a sound separating apparatus, a sound separating method, a sound separating program, and a computer-readable recording medium, which can reduce spectrum discontinuity, thereby improving sound quality in separating the sounds.

### Means for Solving Problem

A sound separating apparatus according to the invention of claim 1 includes a converting unit that respectively converts, into frequency domains by a time unit, signals of two channels where the signals represent sounds from a plurality of sound sources; a localization-information calculating unit that calculates localization information on the signals of two channels converted into the frequency domains by the converting unit; a cluster analyzing unit that classifies into a plurality of clusters the localization information calculated by the localization-information calculating unit and calculates central values of respective clusters; and a separating unit that inversely converts into a time domain values corresponding to the central values calculated by the cluster analyzing unit and the localization information calculated by the localization-information calculating unit, and separating a sound from a given sound source included in the sound sources.

A sound separating method according to the invention of claim 11 includes a converting step that respectively converts, into frequency domains by a time unit, signals of two channels where the signals represent sounds from a plurality of sound sources; a localization-information calculating step that calculates localization information on the signals of two channels converted into the frequency domains by the converting unit; a cluster analyzing step that classifies, into a plurality of clusters, the localization information calculated by the localization-information calculating unit and calculates central values of respective clusters; and a separating step that inversely converts, into a time domain, values corresponding to the central values calculated by the cluster analyzing unit and the localization information calculated by the localization-information calculating unit, and separating a sound from a given sound source included in the sound sources.

A sound separating program according to the invention of claim 12 causes a computer to execute the sound separating method above.

A computer-readable recording medium according to the invention of claim 13 has recorded therein the sound separating program above.

### BRIEF DESCRIPTION OF DRAWINGS

FIG. 1 is a block diagram showing a functional configuration of a sound separating apparatus according to an embodiment of the present invention;

FIG. 2 is a flowchart of processing of the sound separating method according to the embodiment of the present invention;

FIG. 3 is a block diagram of a hardware configuration of the sound separating apparatus;

FIG. 4 is a block diagram of a functional configuration of a sound separating apparatus according to a first example;

FIG. 5 is a flowchart of processing of the sound separating method according to the first example;

FIG. 6 is a flowchart of estimation processing of the localization position of the sound source according to the first example;

FIG. 7 is an explanatory diagram showing two localization positions and the actual level difference for a certain frequency;

FIG. 8 is an explanatory diagram showing the distribution of weighting coefficients to two localization positions;

FIG. 9 is an explanatory diagram showing processing of shifting a window function;

FIG. 10 is an explanatory diagram showing an input situation of sound to be separated;

FIG. 11 is a block diagram of a functional configuration of a sound separating apparatus according to a second example; and

FIG. 12 is a flowchart of estimation processing of the localization position of the sound source according to the second example.

### EXPLANATIONS OF LETTERS OR NUMERALS

101 converting unit
102 localization-information calculating unit
103 cluster analyzing unit
104 separating unit
105 coefficient determining unit
402, 403 STFT unit
404 level-difference calculating unit
405 cluster analyzing unit
406 weighting-coefficient determining unit
407, 408 recomposing unit
1101 phase-difference detecting unit

### BEST MODE(S) FOR CARRYING OUT THE INVENTION

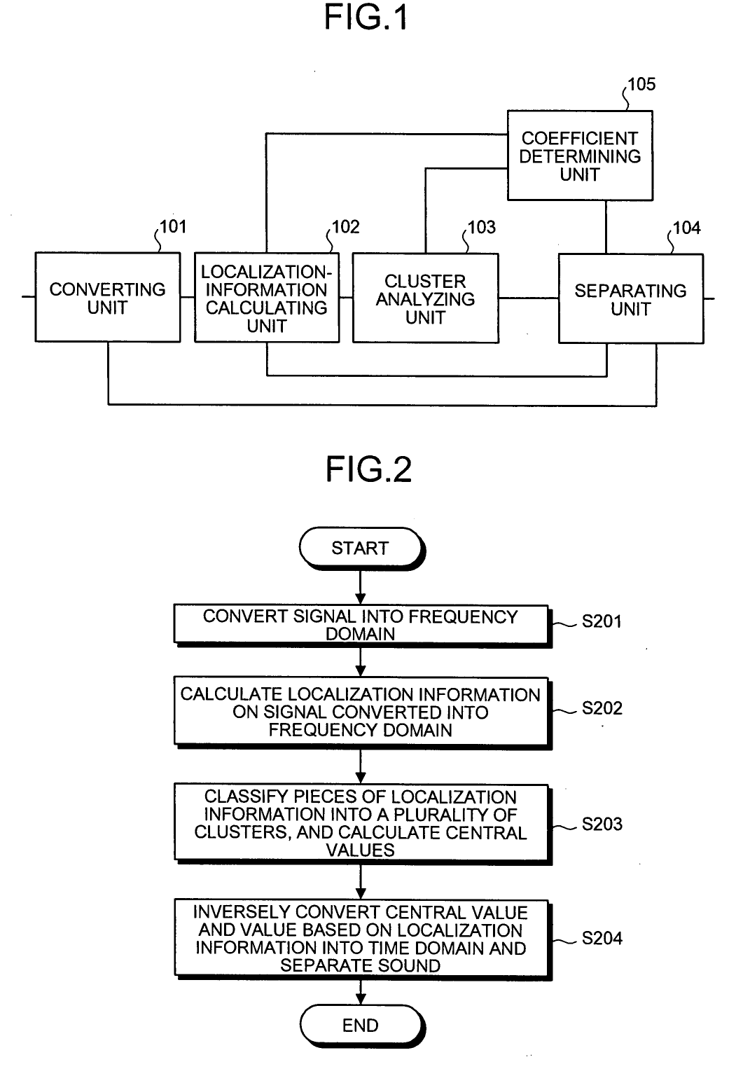

Hereinafter, referring to the accompanying drawings, exemplary embodiments of a sound separating apparatus, a sound separating method, a sound separating program, and a computer-readable recording medium according to the present invention will be described in detail. FIG. 1 is a block diagram of a functional configuration of the sound separating apparatus according to an embodiment of the present invention. The sound separating apparatus according to the embodiment includes a converting unit 101, a localization-information calculating unit 102, a cluster analyzing unit 103, and a separating unit 104. The sound separating apparatus can also include a coefficient determining unit 105.

The converting unit 101 converts signals of two channels representing sounds from multiple sound sources into frequency domains by a time unit, respectively. The signals of two channels may be a stereo signal of sounds of two channels, in which one is output to a left speaker and the other is output to a right speaker. This stereo signal may be a voice signal, or may be an acoustic signal. A short-time Fourier transform may be used for the transformation in this case. The short-time Fourier transform, a kind of a Fourier transform, is a technique of dividing the signal into small blocks in time to partially analyze the signal. Besides the short-time Fourier transform, a normal Fourier transform may be used or any transformation technique such as generalized harmonic analysis (GHA), a wavelet transformation and the like may be employed provided the technique is a transformation technique for analyzing what kind of frequency component is included in the observed signal on a time basis.

The localization-information calculating unit 102 calculates localization information on the signals of two channels converted into the frequency domains by the converting unit 101. The localization information may be defined as a level difference between the frequencies of the signals of two channels. The localization information may also be defined as a phase difference between the frequencies of the signals of two channels.

The cluster analyzing unit 103 classifies into clusters the localization information calculated by the localization-information calculating unit 102, and calculates central values of respective clusters. The number of the clusters classified can coincide with the number of sound sources to be separated, in this case, when there are two sound sources, there are two clusters; and for three sound sources, three clusters. The central value of the cluster may be defined as a center value of the cluster. The central value of the cluster may also be defined as a mean value of the cluster. This central value of the cluster may be defined as a value representing a localization position of each of the sound sources.

The separating unit 104 inversely converts values corresponding to the central values calculated by the cluster analyzing unit 103 and the localization information calculated by the localization-information calculating unit 102 into the time domain to thereby separate a sound from a given sound source included in the sound sources. A short-time inverse Fourier transform is used as the inverse transformation in the case of the short-time Fourier transform, and GHA and the wavelet transformation separate the sound signal by executing the inverse transformation corresponding to each of them. As described above, the inverse transformation into the time domain makes it possible to separate the sound signal for each sound source.

The coefficient determining unit 105 determines weighting coefficients based on the central values calculated by the cluster analyzing unit 103 and the localization information calculated by the localization-information calculating unit 102. The weighting coefficient may be defined as a frequency component allocated to each sound source.

When the coefficient determining unit 105 is provided, the separating unit 104 inversely converts the values corresponding to the weighting coefficients calculated by the coefficient determining unit 105, and the values corresponding to the central values calculated by the cluster analyzing unit 103 and the localization information calculated by the localization-information calculating unit 102 to enable separation of the sound from the given sound source included in the sound sources. The separating unit 104 can also inversely convert the values obtained by multiplying two respective signals converted into the frequency domains by the converting unit 101 by the weighting coefficients determined by the coefficient determining unit 105.

FIG. 2 is a flowchart of processing of the sound separating method according to the embodiment of the present invention. First, the converting unit 101 converts two signals representing the sounds into the frequency domains by a time unit, respectively (step S201). Next, the localization-information calculating unit 102 calculates the localization information on two signals converted into the frequency domains by the converting unit 101 (step S202).

Next, the cluster analyzing unit 103 classifies into clusters the localization information calculated by the localization-information calculating unit 102, and calculates the central values of the respective clusters (step S203). The separating unit 104 inversely converts the values corresponding to the central values calculated by the cluster analyzing unit 103 and the localization information calculated by the localization-information calculating unit 102 into the time domain (step S204). Thereby, it is possible to separate the sound signal into the sounds of the sound sources.

Incidentally, at step S204, the coefficient determining unit 105 determines the weighting coefficient based on the central value calculated by the cluster analyzing unit 103 and the localization information calculated by the localization-information calculating unit 102, and the separating unit 104 inversely converts the values corresponding to the weighting coefficients calculated by the coefficient determining unit 105, and the values corresponding to the central values calculated by the cluster analyzing unit 103 and the localization information calculated by the localization-information calculating unit 102, thereby allowing a sound from the given sound source included in the sound sources to be separated. The separating unit 104 may also inversely convert the values obtained by multiplying two respective signals converted into the frequency domains by the converting unit 101 by the weighting coefficient determined by the coefficient determining unit 105.

### EXAMPLE

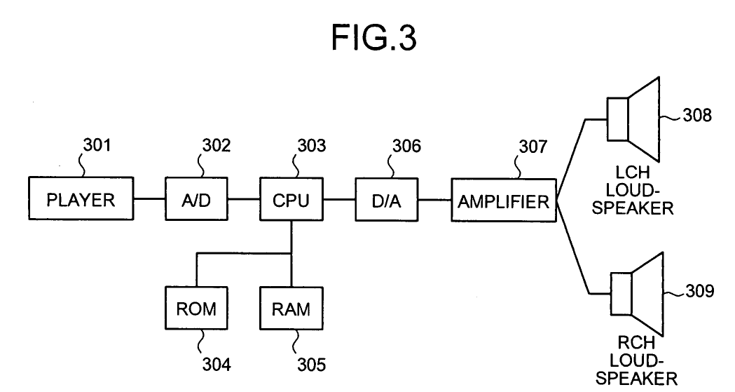

FIG. 3 is a block diagram of a hardware configuration of the sound separating apparatus. A player 301 is a player for reproducing the sound signals, and any player that reproduces the recorded sound signals, for example, a CD, a record, a tape, and the like may be used. In addition, the sound may be the sounds of a radio or a television.

When the sound signal reproduced by the player 301 is an analog signal, an A/D 302 converts the input sound signal into a digital signal to input it into a CPU 303. When the sound signal is input as a digital signal, it is directly input into the CPU 303.

The CPU 303 controls the entire process described in the example. This process is executed by reading a program written in a ROM 304 while using a RAM 305 as a work area. The digital signal processed by the CPU 303 is output to a D/A 306. The D/A 306 converts the input digital signal into the analog sound signal. An amplifier 307 amplifies the sound signal and loudspeakers 308 and 309 output the amplified sound signal. The example is implemented by the digital processing of the sound signal in the CPU 303.

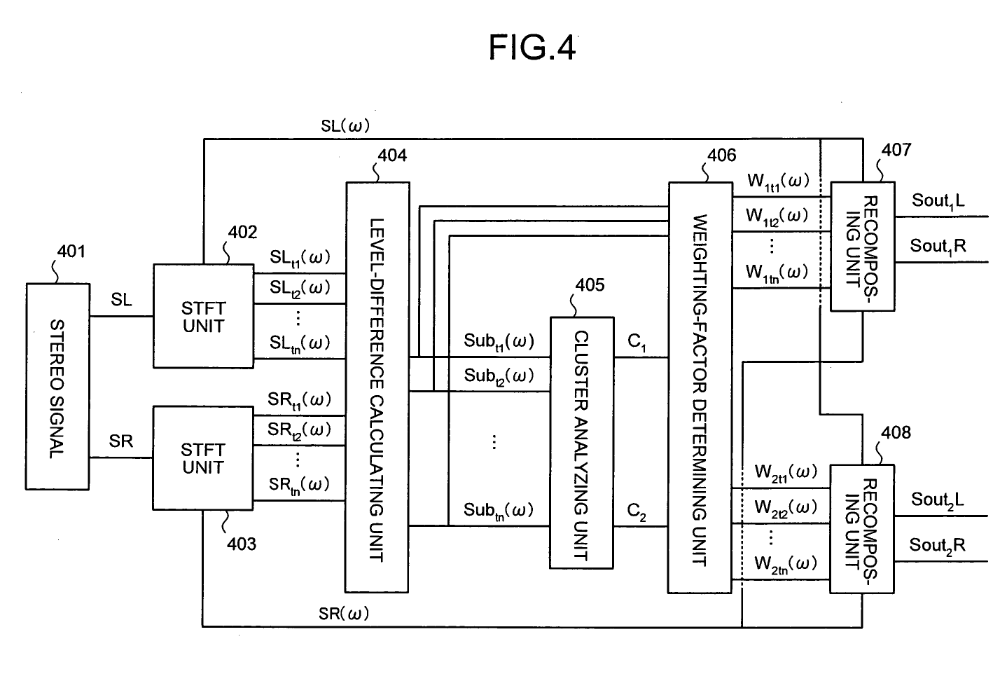

FIG. 4 is a block diagram of a functional configuration of a sound separating apparatus according to a first example. The process is executed by the CPU 303 shown in FIG. 3 reading the program written in the ROM 304 while using the RAM 305 as a work area. The sound separating apparatus is composed of STFT units 402 and 403, a level-difference calculating unit 404, a cluster analyzing unit 405, a weighting-coefficient determining unit 406, and recomposing units 407 and 408.

First, a stereo signal 401 is input. The stereo signal 401 is constituted by a signal SL on the left side and a signal SR on the right side. The signal SL is input into the STFT unit 402, and the signal SR is input into the STFT unit 403.

When the stereo signal 401 is input into the STFT units 402 and 403, the STFT units 402 and 403 perform the short-time Fourier transform on the stereo signal 401. In the short-time Fourier transform, the signal is cut out using a window function having a certain size, and the result is Fourier transformed to calculate a spectrum. The STFT unit 402 converts the signal SL into spectrums SLₜ₁(ω) to SLₜₙ(ω) and outputs the converted spectrums, and the STFT unit 403 converts the signal SR into spectrums SRₜ₁(ω) to SRₜₙ(ω) and outputs the converted spectrums. Although the short-time Fourier transform will be described here as an example, other converting methods such as generalized harmonic analysis (GHA) and the wavelet transformation, which analyze what kind of frequency component is included in the observed signals on a time basis may also be employed.

The spectrum to be obtained is a two-dimensional function in which the signal is represented by time and frequency, and includes both a time element and a frequency element. The accuracy thereof is determined by the window size, which is a width of dividing the signal. Since one set of spectra is obtained for one set window, the temporal variation of the spectrum is obtained.

The level-difference calculating unit 404 calculates respective differences between output powers (|SLₜₙ(ω)| and |SRₜₙ(ω)|) from the STFT units 402 and 403 from t1 to tn. The resulting level differences Subₜ₁(ω) to Subₜₙ(ω) are output to the cluster analyzing unit 405 and the weighting-coefficient determining unit 406.

The cluster analyzing unit 405 inputs the obtained level differences Subₜ₁(ω) to Subₜₙ(ω), and classifies them into the respective clusters with the number of sound sources. The cluster analyzing unit 405 outputs localization positions Cᵢ (i is the number of sound sources) of the sound sources calculated from the center positions of the respective clusters. The cluster analyzing unit 405 calculates the localization position of the sound source from the level difference between the right and left sides. At that time, when the generated level differences are calculated on a time basis and classified into the clusters corresponding in quantity with the sound sources, the center of each cluster can be defined as the position of the sound source. As indicated in the drawing, the number of sound sources is assumed as two and the localization positions C₁ and C₂ are output.

The cluster analyzing unit 405 calculates a near sound source position by performing the processing to a frequency-decomposed signal on each frequency, and averaging the cluster center of each frequency. In this example, the localization position of the sound source is obtained by using cluster analysis.

The weighting-coefficient determining unit 406 calculates the weighting coefficient according to a distance of the localization position calculated by the cluster analyzing unit 405, and the level difference of each frequency calculated by the level-difference calculating unit 404. The weighting-coefficient determining unit 406 determines allocation of the frequency component to each sound source based on the level differences Subₜ₁(ω) to Subₜₙ(ω) that are output from the level-difference calculating unit 404, and the localization positions Cᵢ, and outputs them to the recomposing units 407 and 408. W₁ₜ₁(ω) to W₁ₜₙ(ω) are input into the recomposing unit 407, and W₂ₜ₁(ω) to W₂ₜₙ(ω) are input into the recomposing unit 408. Note herein that the weighting-coefficient determining unit 406 is not required, and the output to the recomposing unit 407 can be determined according to the obtained localization position and level difference.

Spectrum discontinuity is reduced by a distribution to each sound source by multiplying the weighting coefficient corresponding to the distance between the cluster center and each data by the frequency component. In order to prevent degradation of sound quality of the signal re-composed by the discontinuity of spectrum, each of the frequency components is not allocated only to any one of the sound sources, but the frequency component is allocated to all the sound sources by weighting to the level difference based on the distance between each cluster center and the level difference. As a result, a certain frequency component may not take a remarkably small value in each sound source, so that continuity of the spectrum is maintained to some extent, resulting in improved sound quality.

The recomposing units 407 and 408 re-compose (IFFT) based on the weighted frequency components and output the sound signals. Namely, the recomposing unit 407 outputs Sout₁L and Sout₁R, and the recomposing unit 408 outputs Sout₂L and Sout₂R. The recomposing units 407 and 408 determine the frequency components of the output signals and re-compose them by multiplying the weighting coefficients calculated by the weighting-coefficient determining unit 406 and the original frequency components from the STFT units 402 and 403. Incidentally, when the STFT units 402 and 403 perform short-time Fourier transform, short-time inverse Fourier transform is performed, whereas when GHA and the wavelet transformation are performed, the inverse transformation corresponding to each thereof is executed.

### First Example

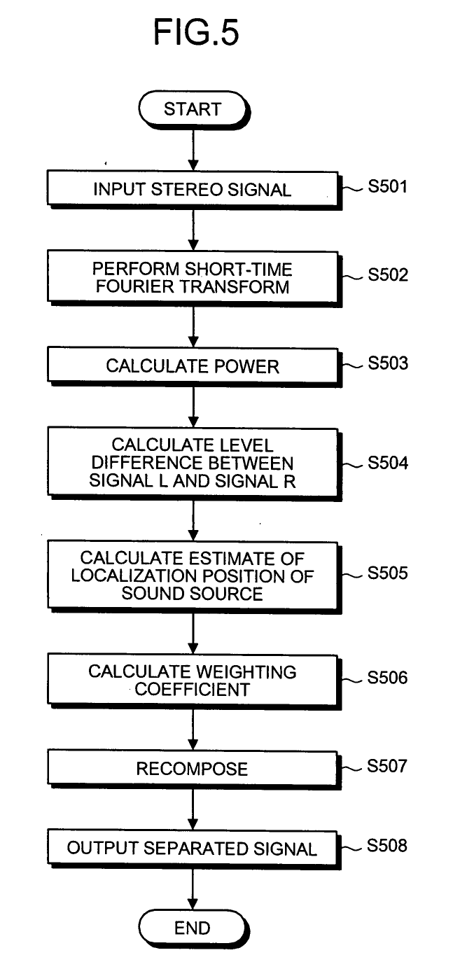

FIG. 5 is a flowchart of the processing of the sound separating method according to the first example. First, the stereo signal 401 to be separated is input (step S501). Next, the STFT units 402 and 403 perform the short-time Fourier transform of the signal (step S502), and convert it into the frequency data for each given period of time. Although this data is represented by a complex number, an absolute value thereof indicates the power of each frequency. Preferably, the window width of the Fourier transform is approximately 2048 to 4096 samples. Next, this power is calculated (step S503). Namely, this power is calculated for both the L channel signal (L signal) and the R channel signal (R signal).

Next, the level difference between the L signal and the R signal for each frequency is calculated by subtracting the respective signals (step S504). If the level difference is defined as “(power of L signal)−(power of R signal)”, this value will take a positive value that is high in a low frequency, when the sound source (contrabass or the like), in which the ratio of the power in the low frequency is larger, is sounding on the L side, for example.

Next, an estimate of the localization position of the sound source is calculated (step S505). Namely, for mixed sound sources, the position where each sound source is respectively localized is calculated. Once the localization position is known, the distance between the position and the actual level difference will be then considered for every frequency, and the weighting coefficient will be calculated according to the distance (step S506). All the weighting coefficients are calculated, multiplied by the original frequency components to form the frequency components of each sound source, and are re-composed by inverse Fourier transform (step S507). Separated signals are then output (step S508). Namely, the re-composed signal is output as the signal being respectively separated for every sound source.

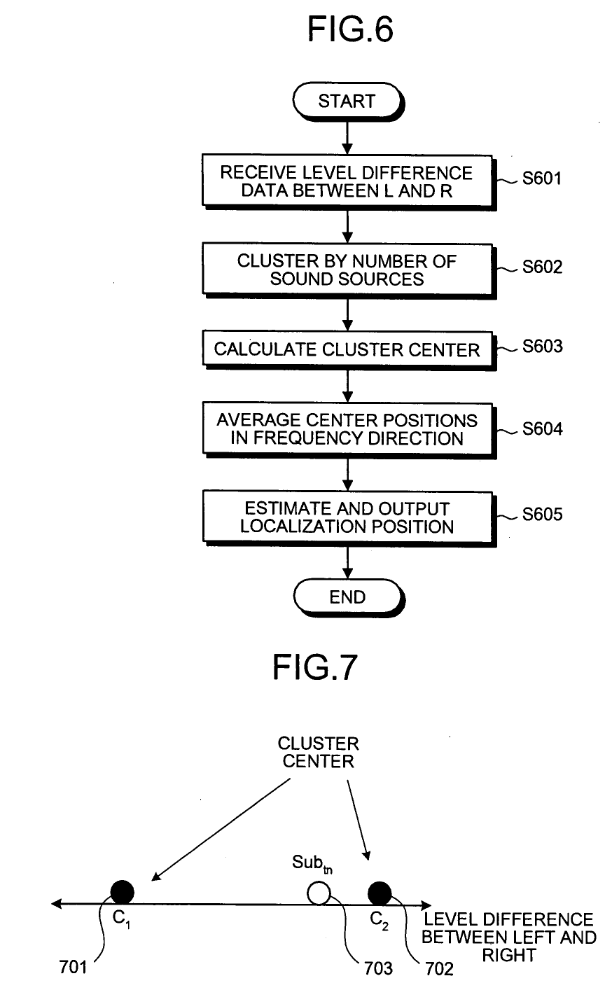

FIG. 6 is a flowchart of estimation processing of the localization position of the sound source according to the first example. Time is divided by the short-time Fourier transform (STFT), and the level difference (unit: dB) between the L channel signal and the R channel signal at each frequency is stored as data for each divided time.

First, data of the level difference between L and R are received (step S601). Here, the data of the level difference for each time are clustered by the number of sound sources for each frequency among these (step S602). Subsequently, the cluster center is calculated (step S603). A k-means method is used for the clustering, and here, it is a condition that the number of sound sources included in this signal be known in advance. It can be considered that the calculated center (as many centers as the number of sound sources) is a location where occurrence frequency at that frequency is high.

After performing this operation to each frequency, the center positions are averaged in a frequency direction (step S604). As a result, the localization information of the entire sound source can be obtained. Subsequently, the averaged value is defined as the localization position of the sound source (unit: dB), and the localization position is estimated and output (step S605).

Next, the cluster analysis will be described. The cluster analysis is an analysis for grouping data such that data that are similar to each other are grouped into the same cluster, and data that are not similar are grouped into different clusters on the assumption that data that are similar to each other behave in the same way. The cluster is a set of data that is similar to other data within that cluster but is not similar to data within a different cluster. In this analysis, the distance is usually defined by assuming that the data are points within a multidimensional space, and the data whose distance is close to each other are assumed similar. In the distance calculation, category data is quantified to calculate the distance.

The k-means method is a kind of clustering, and the data are thereby divided into given k clusters. The central value of the cluster is defined as a value representing the cluster. By calculating the distance to the central value of the cluster, it is determined to which cluster the data belongs. In this case, the data is distributed to the closest cluster.

Subsequently, the central value of the cluster is updated after data distribution to the cluster is completed for all the data. The central value of the cluster is a mean value of all the points. The operation is repeated until a total of the distance between all the data and the central value of the cluster to which the data belong becomes the minimum (until the central value is no longer updated).

Brief description of an algorithm of the k-means method is as follows.

1. Initial cluster centers of K are determined.

2. All the data are classified into the cluster with the cluster center closest thereto.

3. A newly formed center of distribution of the cluster is defined as the cluster center.

4. If all new cluster centers are the same as before, the process is completed, but if not, the process returns to 2.

In this way, the algorithm gradually converges on a local optimum solution.

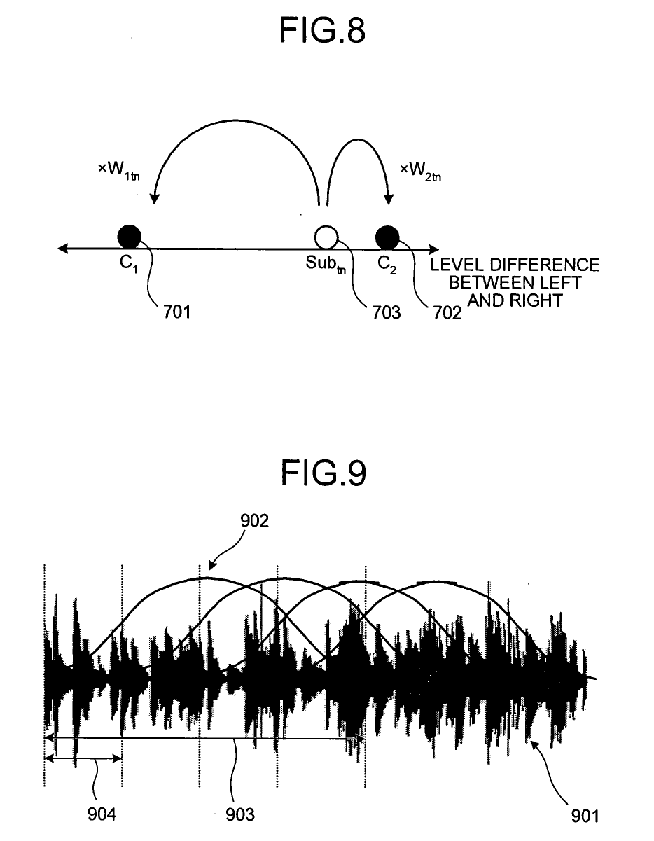

The calculation of the weighting coefficient will be described using FIG. 7 and FIG. 8. In the description, the number of sound sources is two, however, the number of sound sources may actually be three or more. FIG. 7 is an explanatory diagram showing two localization positions and the actual level difference in a certain frequency. Two localization positions are indicated by 701 (C₁) and 702 (C₂). The localization position C₁ and the localization position C₂ that are the cluster centers are obtained by clustering, while a situation where an actual level difference 703 (Subₜₙ) is given is shown.

In this case, it is possible to consider that the frequency emitted from the localization position C₂ is higher since the actual level difference 703 is close to a position of the localization position C₂, while it is considered that a position of the level difference is located between them since it is emitted also from the localization position C₁ in practice although it is a small amount. Hence, if this frequency is distributed only to the localization position C₂ that is closer thereto, neither the localization position C₁ nor the localization position C₂ can obtain exact frequency structures.

FIG. 8 is an explanatory diagram showing the distribution of the weighting coefficients to two localization positions. As shown in FIG. 8, the weighting coefficient Wᵢₜₙ (W₁ₜₙ and W₂ₜₙ in FIG. 8) according to the distance is considered, and the original frequency components are multiplied by the weighting coefficient Wᵢₜₙ, so that the suitable frequency components are distributed to both of them. The sum of the weighting coefficients Wᵢₜₙ must be 1 for each frequency. In addition, the closer the distance between the localization positions C₁ and C₂, and the actual level difference Subₜₙ, the larger the value of Wᵢₜₙ must be.

For example, the weighting coefficient may be defined as Wᵢₜₙ=a(|Subtn−ci|) (where 0<a<1), and the Wᵢₜₙ may be thereafter normalized so that the sum becomes 1 for each frequency. Symbol a in the equation may be set to a suitable value within a range for satisfying 0<a<1.

In addition, the weighting coefficient used for an operation of the recomposing units 407 and 408 is defined as Wᵢₜₙ(ω). Here, values obtained by multiplying the outputs of the STFT units 402 and 403 by it for the corresponding frequency are defined as SLᵢₜₙ(ω) and SRᵢₜₙ(ω).

SLᵢₜₙ=Wᵢₜₙ(ω)·SLₜₙ(ω)

SRᵢₜₙ=Wᵢₜₙ(ω)·SRₜₙ(ω)

As a result of performing such weighting, SLᵢₜₙ(ω) will represent a frequency structure for generating the L side of the sound source i at a time tn and SRᵢₜₙ(ω) will similarly represent a frequency structure for generating the R side thereof, so that when inverse Fourier transform is performed, if the frequency structures are connected at each time interval, the signal of the sound source i alone will be extracted.

For example, when the number of sound sources is two,

SL₁ₜₙ=W₁ₜₙ(ω)·SLₜₙ(ω)

SR₁ₜₙ=W₁ₜₙ(ω)·SRₜₙ(ω)

SL₂ₜₙ=W₂ₜₙ(ω)·SLₜₙ(ω)

SR₂ₜₙ=W₂ₜₙ(ω)·SRₜₙ(ω)

is obtained, inverse Fourier transform is performed and if connected at each time interval, the signal of each sound source will be extracted.

FIG. 9 is an explanatory diagram showing the processing of shifting the window function. Overlaps of the window function of STFT will be described using FIG. 9. A signal is input as shown by an input waveform 901, and short-time Fourier transform is performed on this signal. This short-time Fourier transform is performed according to the window function shown in a waveform 902. The window width of this window function is as shown in a zone 903.

Generally, a discrete Fourier transform analyzes a zone of finite length, and in that case, processing is performed assuming that the waveform within the zone is periodically repeated. For that reason, discontinuity occurs in a joint portion between the waveforms, resulting in higher harmonics being included when the analysis is performed as it is.

As an improvement technique for this phenomenon, there is a technique of multiplying the window function within an analysis zone. While various window functions are proposed, it is effective in reducing the discontinuity of the joint portion by suppressing values of both ends of the zone low in general.

This processing is performed for every zone when performing the short-time Fourier transform, and in that case, it is considered that an amplitude becomes different from that of the original waveform (it decreases or increases depending on the zone) upon recomposition due to the window function. In order to solve this, the analysis may be performed while shifting the window function indicated by the waveform 902 for every certain zone 904 as shown in FIG. 9, values at the same time may be added to each other upon recomposition, and a suitable normalization according to a shift width indicated by the zone 904 may be thereafter performed.

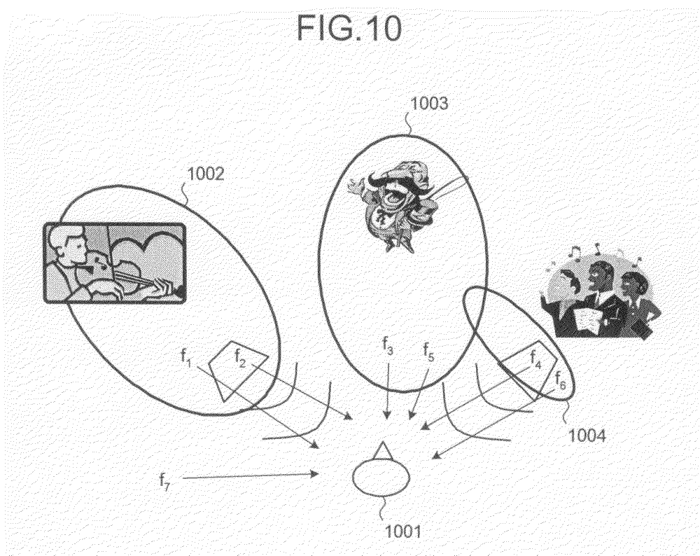

FIG. 10 is an explanatory diagram showing an input situation of the sound to be separated. The recording apparatus 1001 records the sounds flowing from sound sources 1002 to 1004. The sounds of frequencies f₁ and f₂, frequencies f₃ and f₅, and frequencies f₄ and f₆ flow from the sound source 1002, the sound source 1003, and the sound source 1004, respectively, and all these mixed sounds are recorded by the recording apparatus.

In this embodiment, the sounds recorded in this way are clustered and separated into sound sources 1002 to 1004, respectively. Namely, when the separation of the sound of the sound source 1002 is specified, the sound of the frequencies f₁ and f₂ is separated from the mixed sound. When the separation of the sound of the sound source 1003 is specified, the sound of the frequencies f₃ and f₅ is separated from the mixed sound. When the separation of the sound of the sound source 1004 is specified, the sound of the frequencies f₄ and f₆ is separated from the mixed sound.

Although the sound can be separated for each sound source in this embodiment as described above, a sound of a frequency f₇ belonging to neither of the sound sources 1002 to 1004 may be recorded in the mixed sound. In this case, the weighting coefficients corresponding to respective sound sources 1002 to 1004 are multiplied and allocated to the sound of the frequency f₇. Thereby, the sound of the frequency f₇ that is not classified can also be allocated to the sound sources 1002 to 1004, allowing a reduction in discontinuity of spectrum for the sound after separation.

Incidentally, the signal after separation may be further reproduced thereafter through the CPU 303, the amplifier 307, the loudspeakers 308 and 309 that are independent, respectively. Performing subsequent processing independently for every separated sound makes it possible to add independent effects or the like to the separated sounds, respectively, or to physically change the sound source position. The window width of STFT may be changed according to the type of sound source, and the window width of STFT may be changed by a band. A highly accurate result can be obtained by setting suitable parameters.

### Second Example

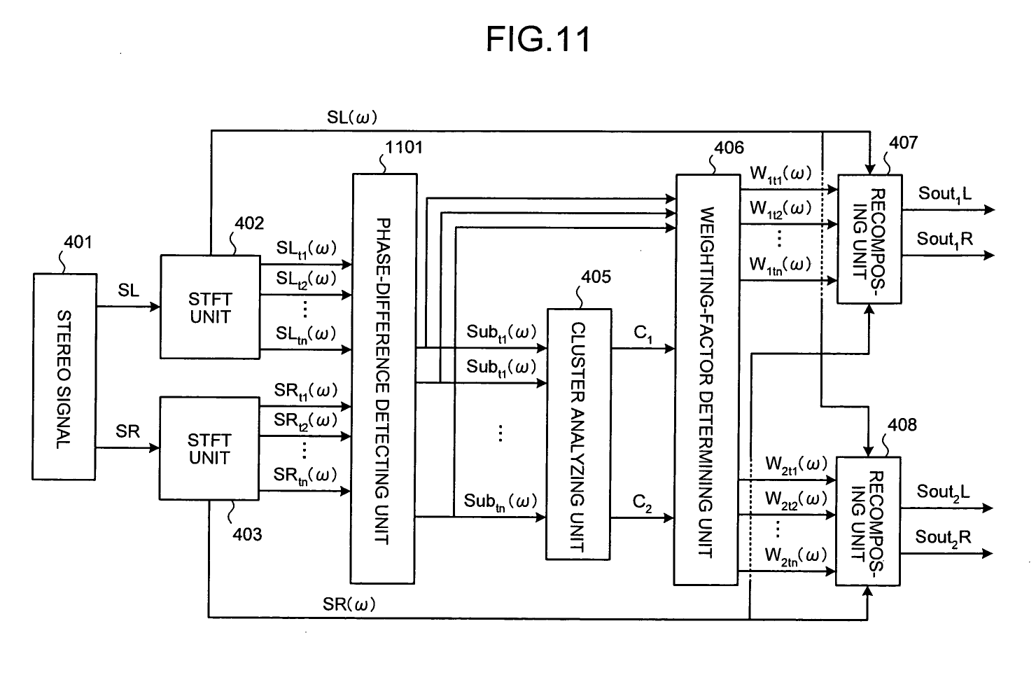

FIG. 11 is a block diagram of a functional configuration of a sound separating apparatus according to a second example. The process is executed by the CPU 303 shown in FIG. 3 reading the program written in the ROM 304 while using the RAM 305 as a work area. Although a hardware configuration thereof is the same as that of FIG. 3, a functional configuration will be as shown in FIG. 11 in which the level-difference calculating unit 404 shown in FIG. 4 is replaced with a phase-difference detecting unit 1101. Namely, the sound separating apparatus is composed of not only the STFT units 402 and 403, the cluster analyzing unit 405, the weighting-coefficient determining unit 406, and the recomposing units 407 and 408, which are the same as the configuration of the first example shown in FIG. 4, but also the phase-difference detecting unit 1101.

First, the stereo signal 401 is input. The stereo signal 401 is constituted by a signal SL on the left side and a signal SR on the right side. The signal SL is input into the STFT unit 402, and the signal SR is input into the STFT unit 403. When the stereo signal 401 is input into the STFT units 402 and 403, the STFT units 402 and 403 perform short-time Fourier transform on the stereo signal 401. The STFT unit 402 converts the signal SL into spectrums SLₜ₁(ω) to SLₜₙ(ω) and outputs the spectrums, and the STFT unit 403 converts the signal SR into spectrums SRₜ₁(ω) to SRₜₙ(ω) and outputs the spectrums.

The phase-difference detecting unit 1101 detects a phase difference. This phase difference and the level difference information shown in the first example, other time differences between both signals, and the like are given as an example of the localization information. A case in which the phase difference between both signals is used will be described in the second example. In this case, the phase-difference detecting unit 1101 calculates the phase differences between the signals from the STFT units 402 and 403 from t1 to tn, respectively. The resultant phase differences Subₜ₁(ω) to Subₜₙ(ω) are output to the cluster analyzing unit 405 and the weighting-coefficient determining unit 406.

In this case, the phase-difference detecting unit 1101 can obtain the phase difference by calculating a product (cross spectrum) of the signal SLₜₙ on the L side converted into the frequency domains, and a complex conjugate number of the signal SRₜₙ on the R side corresponding to the time. For example, when n=1, the phase differences are represented as following equations.

[Equation 1]

SLₜ₁(ω)=A·e^{jω(φ}^{_{L}}⁾

SRₜ₁(ω)=B·e^{jω(φ}_{R})

In this case, the cross spectra is represented as a following equation. Here, symbol * represents a complex conjugate.

[Equation 2]

SLₜ₁(ω)·SRₜ₁(ω)*=A·e^{jω(φ}^{_{L}}⁾·B·e^{-jω(φ}^{_{R}}⁾=A·Be^{jω(φ}^{_{L}}^{-φ}^{_{R}}⁾

Now, the phase difference is represented as a following equation.

[Equation 3]

φ_{L}−φ_{R}

The cluster analyzing unit 405 inputs the obtained phase differences Subₜᵢ(ω) to Subₜₙ(ω), and classifies them into the respective clusters with the number of sound sources. The cluster analyzing unit 405 outputs localization positions Cᵢ (i is the number of sound sources) of the sound sources calculated from the center positions of the respective clusters. The cluster analyzing unit 405 calculates the localization position of the sound source from the phase difference between the R and L sides. At that time, when the generated phase differences are calculated for each time and are classified into the clusters with the number of sound sources, the center of each cluster can be defined as the position of the sound source. Since it is described in the drawing that the number of sound sources is assumed as two, the localization positions C₁ and C₂ are output. Note herein that the cluster analyzing unit 405 calculates a near sound source position by performing the processing to a frequency-decomposed signal at each frequency, and averaging the cluster center of each frequency.

The weighting-coefficient determining unit 406 calculates the weighting coefficient according to the distance between the localization position calculated by the cluster analyzing unit 405, and the phase difference of each frequency calculated by the phase-difference detecting unit 1101. The weighting-coefficient determining unit 406 determines allocation of the frequency component to each sound source based on the phase differences Subₜ₁(ω) to Subₜₙ(ω) that are output from the phase-difference detecting unit 1101, and the localization positions Cᵢ, and outputs them to the recomposing units 407 and 408. W₁ₜ₁(ω) to W₁ₜₙ(ω) are input into the recomposing unit 407, and W₂ₜ₁(ω) to W₂ₜₙ(ω)) are input into the recomposing unit 408. Note herein that the weighting-coefficient determining unit 406 is not required, and the output to the recomposing unit 407 can be determined according to the obtained localization position and phase difference.

The recomposing units 407 and 408 re-compose (IFFT) based on the weighted frequency components and output the sound signals. Namely, the recomposing unit 407 outputs Sout₁L and Sout₁R, and the recomposing unit 408 outputs Sout₂L and Sout₂R. The recomposing units 407 and 408 determine and re-compose the frequency components of the output signals by multiplying the weighting coefficients calculated by the weighting-coefficient determining unit 406 and the original frequency components from the STFT units 402 and 403.

The sound separating method according to the second example is processed as shown in FIG. 5. At step S504, however, the level difference between the L signal and the R signal for each frequency is calculated in the first example, whereas the phase difference between the L signal and the R signal for each frequency is calculated in this second example. Subsequently, an estimate of the localization position of the sound source is calculated according to the phase difference, and the weighting coefficient is calculated according to the distance while considering the distance between the position and the actual phase difference for each frequency. When all the weighting coefficients are calculated, they are multiplied by the original frequency components to form the frequency components of each sound source, and are re-composed by the inverse Fourier transform to output the separated signals.

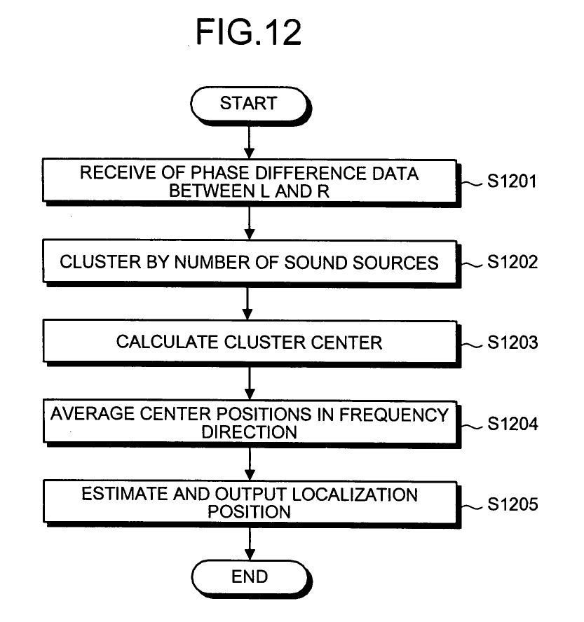

FIG. 12 is a flowchart of estimation processing of the localization position of the sound source according to the second example. Time is divided by the short-time Fourier transform (STFT), and the phase difference between the L channel signal and the R channel signal at each frequency is stored as data for each divided time.

First, data of the phase difference between L and R is received (step S1201). The data of the phase difference for each time are clustered by the number of sound sources for each frequency there among (step S1202). Subsequently, the cluster center is calculated (step S1203).

After calculating the cluster center to each frequency, the center positions are averaged in the frequency direction (step S1204). As a result, the phase difference as the entire sound source can be obtained. Subsequently, the averaged value is defined as the localization position of the sound source, and the localization position is estimated and output (step S1205).

The parameter that estimates the sound source position is different in effectiveness according to the target signal. For example, recording sources mixed by engineers give the localization information as the level difference, and thus neither the phase difference nor the time difference can be used as the effective localization information in this case. Meanwhile, the phase difference and the time difference work effectively when signals recorded in the real environment are input as they are. By changing a unit that detects the localization information according to the sound source, it becomes possible to perform similar processing to various sound sources.

As described above, according to the sound separating apparatus, the sound separating method, the sound separating program, and the computer-readable recording medium of this embodiment, it is possible to separate the sound source from the localization information due to mixing with an unknown arrival time difference. In addition, also when an identified direction and a direction calculated for each frequency are not coincident with each other, the frequency component can be distributed according to the distance between them. As a result of this, the discontinuity of spectrum can be reduced and the sound quality can be improved.

Moreover, using the clustering makes it possible to separate and extract the signal, without depending on the number of sound sources, from the signals of at least two channels for arbitrary numbers of sound sources, while utilizing the level difference between two channels for every frequency.

Additionally, the allocation of the components is performed by the suitable weighting coefficient for each frequency, thereby making it possible to reduce the frequency discontinuity of spectrum and improve the sound quality of the signal after separation. Further, by improving the sound quality after separation, the existing sound source can be processed while maintaining a music appreciation value.

The separation of the sound source in such a manner is applicable to a sound reproducing system or a mixing console. In this case, independent reproduction and independent level adjustment of the sound reproducing system become possible for any musical instrument. The mixing console can remix the existing sound source.

It should be noted that the sound separating method described in the embodiments can be realized by a computer, such as a personal computer and a workstation, executing the program prepared in advance. This program is recorded on a computer-readable recording medium, such as a hard disk, a flexible disk, a CD-ROM, an MO, and a DVD, and is executed by being read from the recording medium by the computer. This program may also be a transmission medium that can be distributed through a network, such as the Internet.

1-13. (canceled)

14. A sound separating apparatus comprising:
a converting unit that respectively converts, into a plurality of frequency domains by a time unit, signals of two channels, the signals representing sound from a plurality of sound sources;
a localization-information calculating unit that calculates localization information regarding the frequency domains;
a cluster analyzing unit that classifies the localization information into a plurality of clusters and calculates a central value of each of the clusters; and
a separating unit that inversely converts, into a time domain, a value that is based on the central value and the localization information, and separates a first sound output from a first sound source among the sound sources, from the sound.

15. The sound separating apparatus according to claim 14, further comprising
a coefficient determining unit that determines a weighting coefficient based on the central value and the localization information, wherein
the separating unit inversely converts the value further based on the weighting coefficient.

16. The sound separating apparatus according to claim 14, wherein the value is a product of the frequency domains and the weighting coefficient.

17. The sound separating apparatus according to claim 14, wherein the localization information is a level difference between the frequency domains.

18. The sound separating apparatus according to claim 14, wherein the signals include a signal of a left channel and a signal of a right channel, and the localization information is a level difference between the frequency domains.

19. The sound separating apparatus according to claim 14, wherein
the localization information is a plurality of level differences,
the clusters are identified by a plurality of initial cluster centers that are obtained in advance, and
the cluster analyzing unit further determines a center of distribution of a set of the classified level differences, and corrects the initial cluster centers to the center of distribution.

20. The sound separating apparatus according to claim 14, wherein the localization information is a phase difference between the frequency domains.

21. The sound separating apparatus according to claim 14, wherein the signals include a signal of a left channel and a signal of a right channel, and the localization information is a phase difference between the frequency domains.

22. The sound separating apparatus according to claim 14, wherein
the localization information is a plurality of phase differences,
the clusters are identified by a plurality of initial cluster centers that are obtained in advance, and
the cluster analyzing unit further determines a center of distribution of a set of the classified level differences, and corrects the initial cluster center to the center of distribution.

23. The sound separating apparatus according to claims 14, wherein the converting unit converts the signals using a window function that shifts the signals at a predetermined time interval.

24. A sound separating method comprising:
converting signals of two channels, respectively, into a plurality of frequency domains by a time unit, the signals representing sound from a plurality of sound sources;
calculating localization information regarding the signals;
classifying the localization information into a plurality of clusters
calculating a central value of each of the clusters;
inversely converting a value that is based on the central value and the localization information into a time domain; and
separating a first sound output from a first sound source among the sound sources, from the sound.

25. A computer-readable recording medium storing therein a program that causes a computer to execute:
converting signals of two channels, respectively, into a plurality of frequency domains by a time unit, the signals representing sound from a plurality of sound sources;
calculating localization information regarding the signals;
classifying the localization information into a plurality of clusters
calculating a central value of each of the clusters;
inversely converting a value that is based on the central value and the localization information into a time domain; and
separating a first sound output from a first sound source among the sound sources, from the sound.
